(19) United States
(12) Patent Application Publication
(10) Pub. No.: US 2003/0205919 A1
(43) Pub. Date: Nov. 6, 2003

(54) Motorcycle saddle assembly

(76) Inventor: Michael W. Hanagan, Hollister, CA (US)

Correspondence Address: PEPE & HAZARD, LLP, 225 ASYLUM ST., HARTFORD, CT, 06103, US

(21) Appl. No.: 10/137,582

(22) Filed: May 2, 2002

(51) Int. Cl. B62J 1/00

(52) U.S. Cl. 297/215.12

(57) ABSTRACT

A tandem saddle assembly for mounting on the frame of a motorcycle has a tandem platform member with a driver and passenger seat sections and a driver backrest pod is secured to the platform adjacent the rear end of the driver section. Synthetic resin cushioning material substantially encapsulates the backrest pod, and fabric covers the cushioning material. Along one side of said driver seat section is a hinge to mount the driver section on a motorcycle frame for pivoting into an open position, and on the other side is a latch to secure it in a closed position. A backrest assembly has an elongated rigid support arm extending through aligned openings in the fabric covering and cushioning material and into a mounting aperture in the pod.

### BACKGROUND OF THE INVENTION

The present invention is directed to motorcycle saddles employing backrests and, more particularly, to such saddles which may be pivoted into a position enabling access to gas tanks and other components therebelow.

Tandem motorcycle seats are well known and are widely employed to enable the motorcycle operator to transport a passenger. Frequently the driver desires to have a backrest for comfort during extended periods of operation, and such backrests are commonly mounted on the frame. As a result, the backrests may interfere with the ability of the driver to pivot the saddle into an open position to access a gas tank fill or other components.

Moreover, providing a rigidly mounted backrest in saddles sometimes provides a substantial increase in cost and complications in the molding operation. Lastly, some motorcycle seats having backrests affixed thereto are less desirable in appearance since the backrest supporting attachment tends to interfere with the appearance or contour of the saddle. In copending application Ser. No. 09/754,549 filed Jan. 5, 2000, there is disclosed an improved saddle in which the backrest is supported in a pod embedded within the saddle.

It is an object of the present invention to provide a novel tandem saddle with a driver backrest and which can be pivoted into an open position without removing the backrest.

It is also an object to provide such a tandem motorcycle seat and backrest which is attractive and relatively long lived.

Another object is to provide such a tandem motorcycle saddle and backrest which can be readily manufactured and disassembled.

### SUMMARY OF THE INVENTION

It has now been found that the foregoing and related objects may be readily attained in a tandem saddle assembly for mounting on the frame of a motorcycle and comprising a tandem platform member with a driver seat section and a passenger seat section, and a driver backrest pod secured to the driver section of the platform member adjacent the rear end of the driver section, and having a mounting aperture in its outer end. An exterior fabric covering and a synthetic resin cushioning material between the fabric covering and the platform member substantially encapsulate the backrest pod. The fabric covering and cushioning material have openings therein aligned with the pod mounting aperture.

Hinge means is provided along one side of the driver seat section of the platform member for hingedly mounting the driver section of the saddle on the motorcycle frame to pivot about a longitudinal axis, and latch means is provided on the other side of the driver seat section of the platform member to secure it to the motorcycle frame. Seated in the backrest pod is a backrest assembly having an elongated rigid support arm having a lower portion extending through the aligned openings in the fabric covering and the cushioning material and into the mounting aperture of the pod. A backrest is mounted on the upper portion of the support, and there is also means releasably securing the support arm in the pod, whereby the driver section of the saddle can be unlatched from the frame and pivoted into an open position to expose underlying elements of the motorcycle with the backrest assembly retained therein.

In one embodiment, the platform member is comprised of abutting separate driver and passenger sections. A second pod is secured to the passenger section of the platform member and a pair of backrests is provided and mounted in the pods.

In another embodiment, the platform member is of unitary construction and both passenger and driver sections are hingedly mounted on the frame, and the saddle assembly includes a second backrest pod secured to the platform member adjacent the rear end of the passenger section. A second passenger backrest assembly is releasably secured in the second backrest pod, both of the backrest assemblies being retained in the pods upon pivoting of the saddle into an open position.

### BRIEF DESCRIPTION OF THE DRAWINGS

FIG. 1 is a side elevational view in partial section of a tandem motorcycle saddle embodying the present invention and showing the backrests in normal and forwardly pivoted positions;

FIG. 2 is a partially exploded view of the saddle of FIG. 1 showing the hinge and latch elements on the saddle and on a fragmentarily illustrated motorcycle frame;

FIG. 3 is a fragmentary and enlarged view of the pod and platform;

FIG. 4 is a perspective view of the saddle pivoted into an open position on the fragmentarily illustrated motorcycle frame;

FIG. 5 is a perspective view of the pod and fragmentarily illustrated backrest arm with a portion of the pod housing broken away to illustrate internal construction; and

FIG. 6 is a fragmentary perspective view of a motorcycle having a tandem saddle embodying the present invention in which only the driver portion is pivotable.

### DETAILED DESCRIPTION OF THE ILLUSTRATED EMBODIMENTS

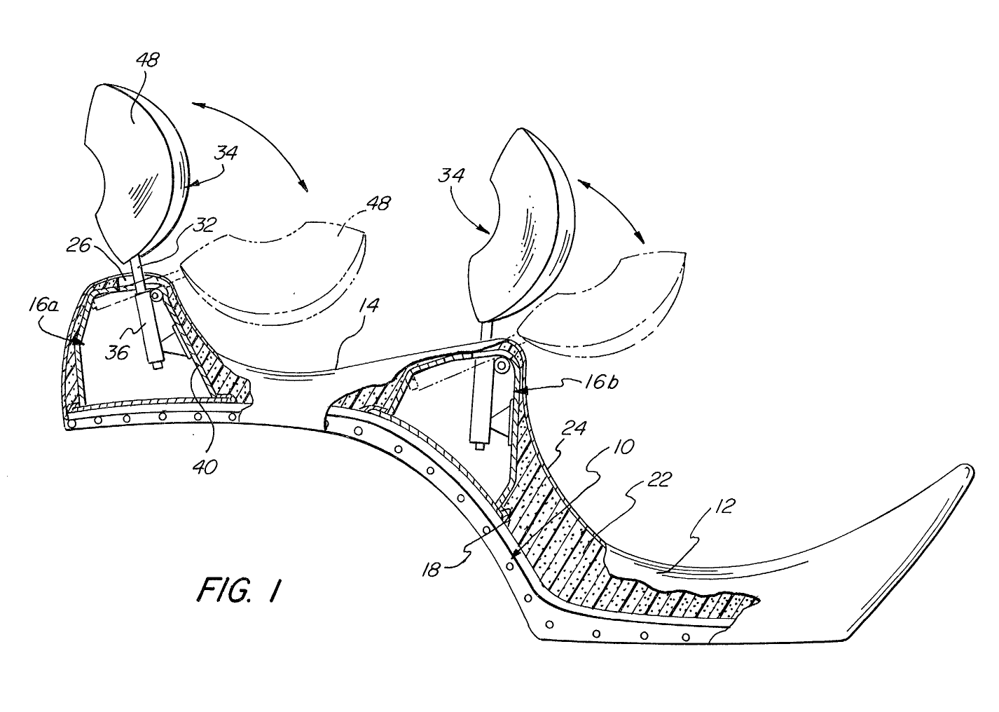

As seen in FIGS. 1-4 of the attached drawings, a tandem saddle embodying the present invention has a platform member generally designated by the numeral 10 complementarily configured for the motorcycle upon which it is to be mounted. It includes a driver portion 12 and a passenger portion 14.

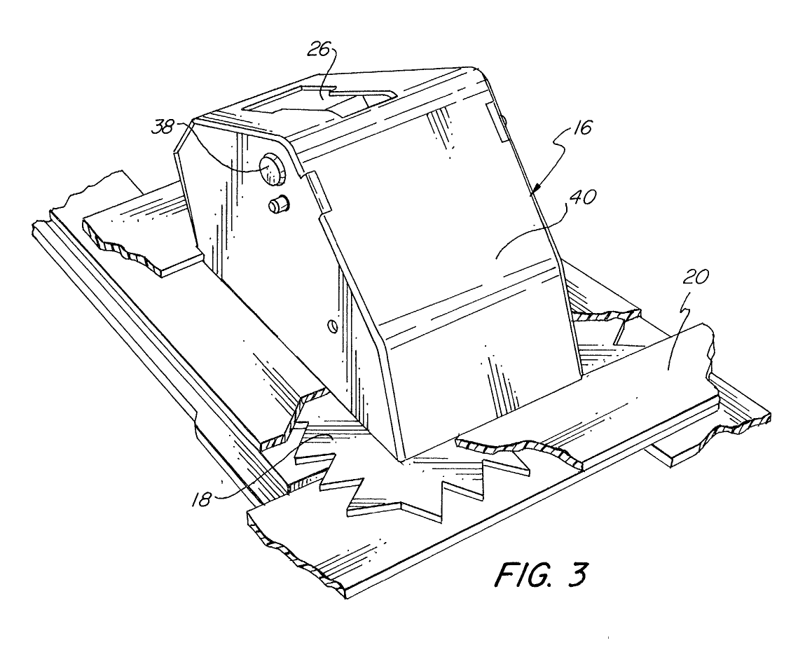

A pair of backrest mounting pods generally designated by the numerals 16a, 16b have mounting flanges 18 extending about their base for mounting on the platform member 10. In FIG. 3, the flange 18 is shown as embedded in the fiberglass layers 20 used to mold the platform member 10. Fasteners (not shown) may also be used to secure the pods 16 to the platform member 10, especially when it is formed of metal.

The pods 16 are embedded in a flexible synthetic resin foam cushion 22 which generally follows the contour of the platform member 10 and is bonded thereto. Overlying the cushion 18 is the flexible cover 24 of leather or synthetic resin which is secured to the platform member 10.

The pods 16 have an aperture 26 in their upper ends and the foam cushion 22 and cover 24 have passages 28,30 therethrough which are aligned with the apertures 26. Extending through the passages 28, 30 and apertures 26 are the elongated arms 32 of the backrests generally designated by the numerals 34a, 34b. The arms 32 seat in tubular receptacles 36 which are pivotably supported on a shaft 38 journalled in the side walls of the pod housing 40 so that they can be pivoted forwardly as seen in FIG. 1. Biasing the tubular receptacles 36 and arms 32 rearwardly is a torsion spring 42 disposed about the shaft 38. The arms 32 can be releasably secured in the receptacles 36 by set screws 44 which are accessible through the aperture 46 in the base of the pod 16 and a cooperating aperture in the platform member 10. This pod assembly and its operation are discussed in greater detail in the aforementioned copending application.

As also seen in the drawings, a cushioned backrest member 48 is secured to the upper end of the arms 32.

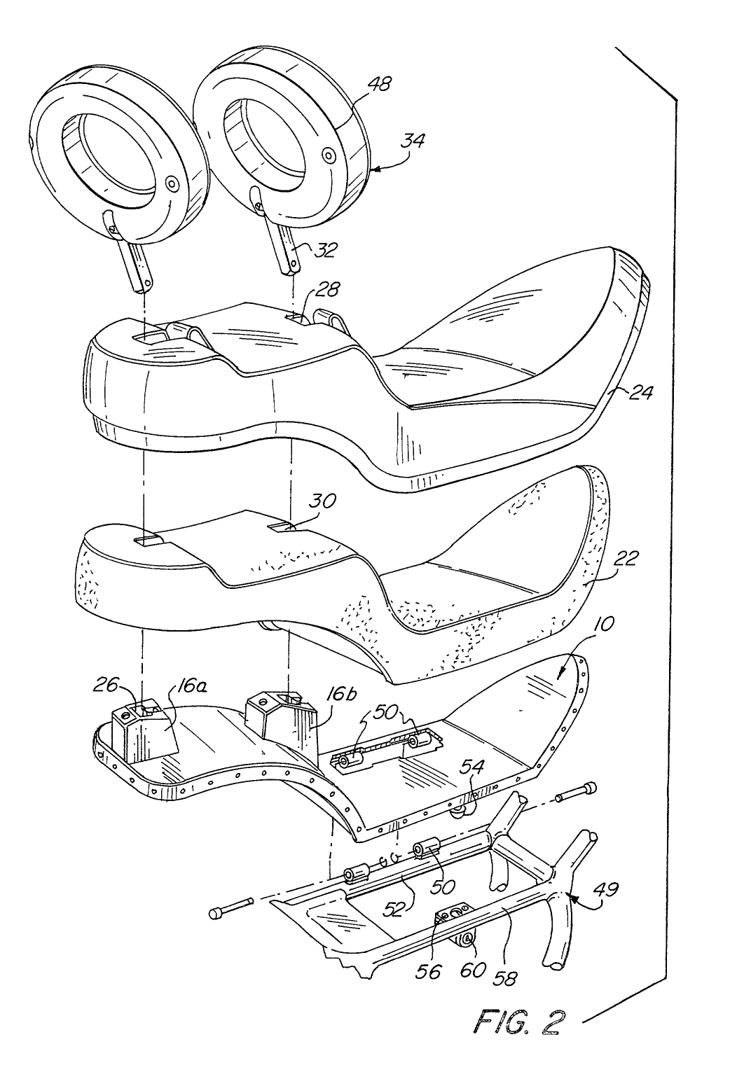

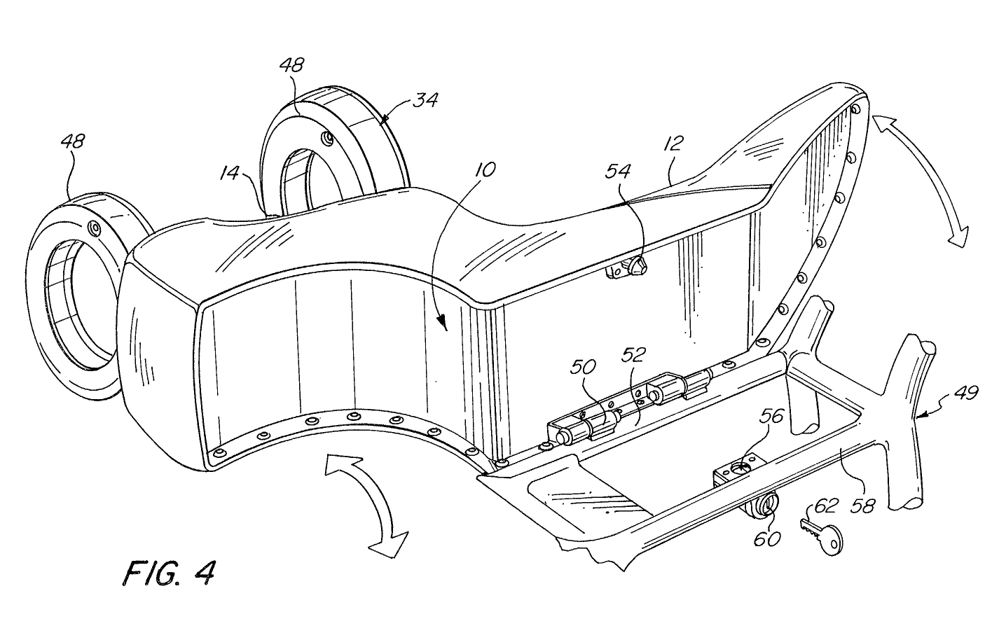

Turning to FIGS. 2 and 4, the saddle is pivotably supported on the fragmentarily illustrated frame 48 of the motorcycle by a pair of hinges 50 secured along one side of the platform member 10 and along one side bar 52 of the frame generally designated by the numeral 49. In the other side of the platform member 10 is a latch pin 54 which seats in a latch pin receptacle 56 mounted on the opposite side bar 58 and which includes a lock 60 operable by the key 62.

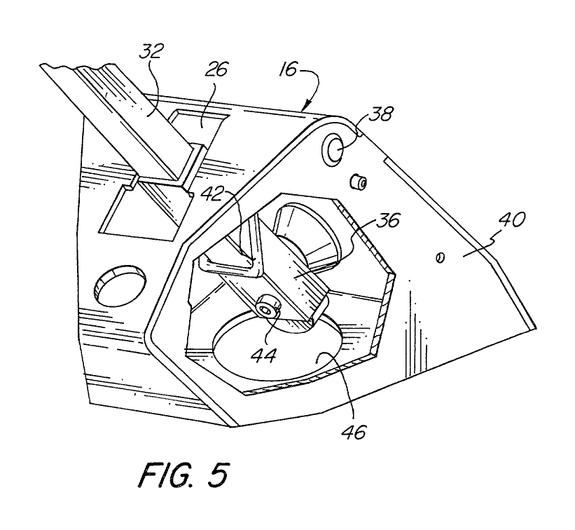

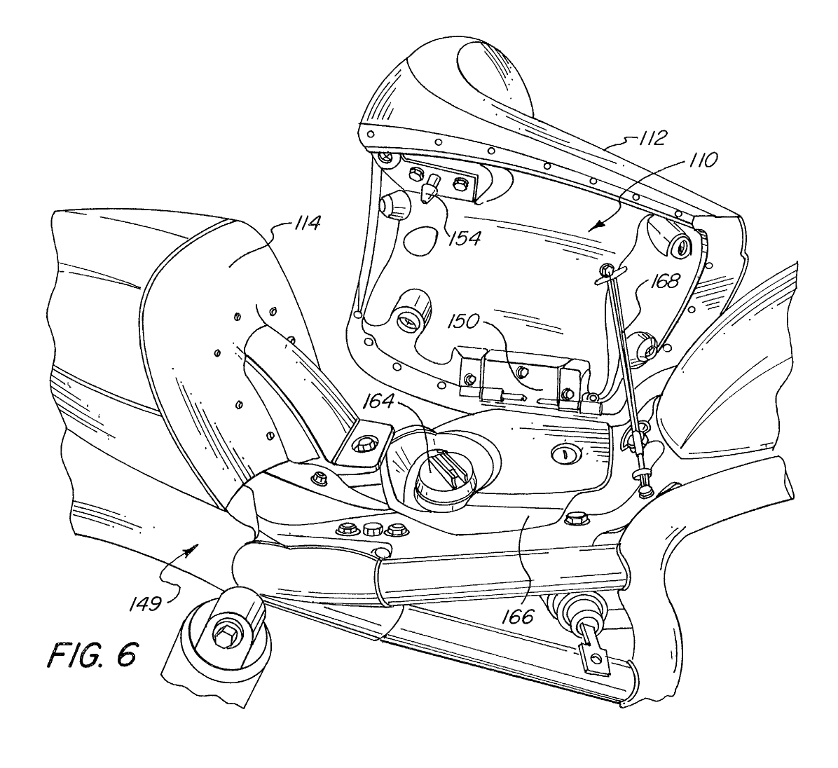

Turning now to FIG. 6, therein illustrated is another embodiment of the present invention in which only the driver portion 112 of a tandem saddle is pivotably mounted. The saddle is fabricated as two separate components and the passenger portion 14 is secured to the motorcycle frame 149 in a conventional manner. The driver portion 112 is fabricated as indicated with respect to the embodiment of FIGS. 1-5 and has a pod (not shown) in which is seated a backrest (not shown) located adjacent the rearward end of the driver portion 112 of the platform member 110. In this embodiment a single hinge 150 is employed and the latch pin 154 is located adjacent the rearward end of the platform member 110. The latch receptacle cannot be seen in this perspective view.

As seen in FIG. 6, and as is also the case with respect to the embodiment of FIGS. 1-5, the latch pin 154 holding the saddle can be released to allow pivoting of the saddle to provide access to the fill 164 of the gas tank 166. In the embodiment of FIGS. 1-5, a compartment (not shown) may be provided on the frame below the passenger portion 14 which is similarly accessible upon pivoting of the saddle. In either embodiment, the saddle is pivoted without removing the backrests 34 which are retained therein.

If so desired, a support arm 168 may be pivoted on the frame 48 to support the saddle in the pivoted positions.

In forming the saddle, a mold (not shown) having the desired contours is provided, and the platform member 18 may be previously formed and simply inserted into the mold. Conveniently, the assembly of platform member and cushion is produced in situ in the mold. As seen in FIG. 3, this is accomplished by providing fiberglass reinforcing and resin over the surface of the mold with the exception of a small space which registers with the opening 46 in the base of the pod 16. The mold may have locating pins (not shown) which extend upwardly into index guides (not shown) to effect the desired location of the pod 16 within the mold. Additional fiberglass and resin is placed over the peripheral flange 18 of the base to secure the pod 16 to the platform member 10 as it is formed.

A foamable synthetic resin is then introduced into the mold which is thereafter closed and subjected to the desired heat cycle to expand the synthetic resin to produce the foam which bonds to the fiberglass platform member 10 as a part of the curing process.

The structure can then be removed from the mold and the fabric cover 24 secured thereover in accordance with conventional practice. As molded, the molded cover (not shown) provides a small opening in the cushioning material 22 over the aperture 26 in the pod 16, and the fabric cover 24 likewise has a small aperture therein for passage of the arm 32 of the backrest 34 therethrough. After the saddle has been finished, the backrest assembly 34 may be inserted thereinto and locked in the position by the set screw 44 by inserting a tool through the opening 46, or the saddle may be shipped with the backrest assembly 34 unassembled.

As can be seen, the entire support assembly for the backrest is concealed within the upholstery and, in the event that no backrest is desired and the backrest is removed, the clean, flowing contours of the tandem seat are unbroken by any hardware. However, a backrest can be readily assembled onto the seat by inserting the arm of the backrest into the passage of the pivotable receptacle member and securing it in position by the set screw at its base.

Since the driver backrest can be pivoted forwardly, a passenger can readily board the seat. In the event of an impact, the backrest will pivot forwardly and there is less likelihood of injury to the passenger who may be thrown forwardly against the backrest.

When the driver decides to put fuel in the tank, the lock and latch can be released and the saddle (or driver portion) thereof pivoted upwardly. The backrest will stay in its mounted position.

Thus, it can be seen from the foregoing detailed specification and attached drawings that the novel tandem motorcycle seat assembly of the present invention is one in which the backrest(s) do not interfere with the pivoting of the saddle to access components therebelow and are securely retained in the saddle.

Having thus described the invention, what is claimed is:

1. A tandem saddle assembly for mounting on the frame of a motorcycle comprising:
(a) a tandem platform member with a driver seat section and a passenger seat section;
(b) a driver backrest pod secured to said driver section of said platform member adjacent the rear end of said driver section, said backrest pod having a mounting aperture in its outer end;
(c) an exterior fabric covering;
(d) synthetic resin cushioning material therebetween, substantially encapsulating said backrest pod, said fabric covering and cushioning material having openings therein aligned with said pod mounting aperture;
(e) hinge means along one side of said driver seat section of said platform member for hingedly mounting said section of said saddle on the motorcycle frame to pivot about a longitudinal axis;
(f) latch means on the other side of said driver seat section of said platform member to secure it to the motorcycle frame; and
(g) a backrest assembly having
(i) an elongated rigid support arm having a lower portion extending through said aligned openings in said fabric covering and said cushioning material and into said mounting aperture of said pod;
(ii) a backrest on the upper portion of said support, and
(iii) means releasably securing said support arm in said pod, whereby said driver section of said saddle can be unlatched from the frame and pivoted into an open position to expose underlying elements of the motorcycle with said backrest assembly retained therein.

2. The tandem saddle assembly in accordance with claim 1 wherein said platform member is comprised of abutting separate driver and passenger sections thereof.

3. The tandem saddle assembly in accordance with claim 2 wherein a second pod is secured to said passenger section of said platform member and a pair of backrests is provided and mounted in said pods.

4. The tandem saddle assembly in accordance with claim 1 wherein said platform member is of unitary construction and both sections are hingedly mounted on the frame.

5. The tandem saddle assembly in accordance with claim 4 wherein said saddle assembly includes a second backrest pod, secured to said platform member adjacent the rear end of said passenger section.

6. The tandem saddle assembly in accordance with claim 5 wherein there is included a passenger backrest assembly releasably secured in said second backrest pod, both of said backrest assemblies being retained in said pods upon pivoting of said saddle into an open position.

7. A tandem saddle assembly for mounting on the frame of a motorcycle comprising:
(a) a unitary tandem platform member with a driver seat section and a passenger seat section;
(b) a driver backrest pod secured to said driver section of said platform member adjacent the rear end of said driver section, said backrest pod having a mounting aperture in its outer end;
(c) a passenger backrest pod secured to said passenger section of said platform member adjacent the rear end thereof, said backrest pod having a mounting aperture in its outer end;
(d) an exterior fabric covering;
(e) synthetic resin cushioning material therebetween, substantially encapsulating said backrest pod, said fabric covering and cushioning material having openings therein aligned with said pod mounting aperture;
(f) hinge means along one side of said platform member for hingedly mounting said saddle on the motorcycle frame to pivot about a longitudinal axis;
(g) latch means on the other side of said platform member to secure it to the motorcycle frame; and
(h) a driver backrest assembly having
(i) an elongated rigid support arm having a lower portion extending through said aligned openings in said fabric covering and said cushioning material and into said mounting aperture of said driver section pod;
(ii) a backrest on the upper portion of said support, and
(iii) means releasably securing said support arm in said pod, whereby said saddle can be unlatched from the frame and pivoted into an open position to expose underlying elements of the motorcycle with said backrest assembly retained therein, wherein said saddle assembly includes a second backrest pod, secured to said platform member adjacent the rear end of said passenger section.

8. The tandem saddle assembly in accordance with claim 7 wherein there is included a passenger backrest assembly releasably secured in said passenger backrest pod, both of said backrest assemblies being retained in said pods upon pivoting of said saddle into an open position.
